(19) United States
(12) Patent Application Publication
(10) Pub. No.: US 2015/0020125 A1
(43) Pub. Date: Jan. 15, 2015

(54) SYSTEM AND METHOD FOR PROVIDING INTERACTIVE OR ADDITIONAL MEDIA

(71) Applicant: Monica A. Adjemian, Los Angeles, CA (US)

(72) Inventor: Monica A. Adjemian, Los Angeles, CA (US)

(21) Appl. No.: 14/328,614

(22) Filed: Jul. 10, 2014

Related U.S. Application Data
(60) Provisional application No. 61/845,304, filed on Jul. 11, 2013.

(51) Int. Cl. H04N 21/4722; H04N 21/488; H04N 21/81

(52) U.S. Cl. CPC H04N 21/4722; H04N 21/8133; H04N 21/488
USPC 725/86

(57) ABSTRACT

The present disclosure is related to methods and systems relating to analyzing of media, such that a user may request to view additional content related to content from the analyzed media on secondary or mobile devices capable of receiving or displaying the additional content.

This application claims the benefit of U.S. Provisional Patent Application No. 61/845,304, entitled “MULTI DEVICE INTERACTIVE OR ADDITIONAL MEDIA”, filed on Jul. 11, 2013 to Monica A. Adjemian.

### BACKGROUND OF THE INVENTION

1. Field of the Invention

The present invention is related to the area of television and mobile devices. More particularly, the present invention is related to methods and systems relating to secondary or mobile devices capable of receiving or displaying additional content related to content on streamed or broadcast television.

2. Description of the Related Art

Smartphones, such as the iPhone® from Apple® and Android®-based phones from HTC®, Samsung® or Motorola®, are becoming increasingly popular. Besides their use to place phone calls and transmit messages, smartphones allow users to be connected to the internet from anywhere, anytime via a wireless network (e.g., 3G, 4G, LTE, Bluetooth or WiFi). As smartphones increase in computing power (e.g., memory, graphics, and processing speed), their entertainment and media capabilities are more robust. With a powerful processor and a proper connection speed, a smartphone can be used as an entertainment device, allowing a user to play games alone or with others via a network, download media files, and view media files over the internet. Smartphones and like devices can also be used to view broadcast television, or browse media heavy websites, which stream television or provide video, graphical or text material.

Despite the increase in the use of electronic and mobile devices, such as smartphones, computers, tablets, laptops, MP3 players, personal multimedia players (PMPs), cellular phones or the like, users can only access media related to material seen on broadcast or streamed television to these or like devices having a media playback function. Furthermore, this media can only be accessed by using a complicated process of searching for the desired media over the internet during their spare time at home, then accessing the desired media via the device. Such a complicated process has caused an inconvenience to users of these devices.

Currently, if a viewer is watching a television program, whether they are watching it on a television in broadcast form or a simulcast being streamed online or within an application, if the television program includes any information that the viewer would like to know more about, the viewer has to manually search for this information to access it. There is no mechanism that allows the viewer to automatically receive more information, programming, or material on this related information. Therefore, it may be desirable to create a system that streamlines this process and creates a more interactive experience.

### SUMMARY OF THE INVENTION

One embodiment of the present disclosure may include systems or methods comprising providing additional media to a device in response to a request for such media. Further including analyzing or receiving data regarding an initial program. Additionally, determining requested media based on at least the time of request.

A better understanding of the features and advantages of the present embodiments will be obtained by reference to the following detailed description of the invention and accompanying drawings, which set forth illustrative embodiments in which the principles of the invention are utilized.

### BRIEF DESCRIPTION OF THE DRAWINGS

The accompanying drawings are included to provide a further understanding of the present invention, and are incorporated in and constitute a part of this specification.

FIG. 1 is a flow chart showing the use of the system according to one embodiment of the present disclosure;

FIG. 2 is a flow chart showing the use of the system according to another embodiment of the present disclosure;

FIG. 3 is an overview of the system according to one embodiment of the present disclosure;

FIG. 4 is an exemplary television broadcast, which a user may be viewing and requesting additional information from;

FIG. 5 is another exemplary television broadcast, which a user may be viewing and requesting additional information from;

FIG. 6 is a screenshot of an exemplary television broadcast, which a user may request additional information regarding;

FIG. 7 is an exemplary diagram of the system in use according to one embodiment of the present disclosure.

### DETAILED DESCRIPTION OF THE INVENTION

Embodiments of the invention described herein provide new systems and methods for providing additional material and interactivity to users viewing any media segment, such as a live or prerecorded broadcast television. Although embodiments of the present invention are discussed with specific reference to specific media, such as television broadcast news programs and additional media provided via a mobile device, it is understood that the methods and systems described herein may be applied to any media segment, such as broadcast or streamed show, being shown in real time or prerecorded, and the additional media may be displayed on any display device, or any first source of information that may be supplemented with a second. Overall system architecture and specific algorithms are presented as embodiments of the present invention; however, as stated above, the methods and systems are in no way limited to any particular application.

The present invention is described herein with reference to certain embodiments, but it is understood that the invention can be embodied in many different forms and should not be construed as limited to the embodiments set forth herein. In particular, the invention is described with reference to certain embodiments where a server is accessed by viewers, users, and/or content providers to complete transactions, but in other embodiments, other entities may also interact with the server or portions of the system may take place outside of the server. The present invention may incorporate the use of any electronic device and communication method for carrying out the system.

In the description that follows, numerous details are set forth in order to provide a thorough understanding of the invention. It will be appreciated by those skilled in the art that variations of these specific details are possible while still achieving the results of the invention. Well-known elements and processing steps are generally not described in detail in order to avoid unnecessarily obscuring the description of the invention.

Embodiments of the invention are described herein with reference to illustrations that are schematic illustrations of embodiments of the invention. As such, the actual size, components and features can be different, and variations from the shapes of the illustrations as a result, for example, of technological capabilities, manufacturing techniques and/or tolerances are expected. Embodiments of the invention should not be construed as limited to the particular shapes or components of the regions illustrated herein but are to include deviations in shapes/components that result, for example, from manufacturing or technological availability. The regions illustrated in the figures are schematic in nature and their shapes are not intended to illustrate the precise shape or functionality of a feature of a device and are not intended to limit the scope of the invention. Furthermore, components described as being connected or connections may not be direct. Intervening components or connections may exist. Also, components may be shown as one unit, but may instead be a collection of components or units, or a collection of components or units may exist as one unit. Furthermore, though the accompanying drawings illustrate specific embodiments of the invention, other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer-readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media, such as those supporting the internet or an intranet, cloud or remote storage, or a magnetic storage device, solid-state memories, such as a memory card or other package that houses one or more read-only (non-volatile) memories, random access memories, or other re-writable (volatile) memories; magneto-optical or optical medium, such as a disk or tape; and/or a digital file attachment to e-mail or other self-contained information archive or set of archives is considered a distribution medium equivalent to a tangible storage medium. Accordingly, the disclosure is considered to include any one or more of a computer-readable medium or a distribution medium, as listed herein and including art-recognized equivalents and successor media, in which the software implementations herein are stored. Note that the computer-usable or computer-readable medium could even be paper or another suitable medium upon which the information is printed, as the information can be electronically captured, via, for instance, optical scanning of the medium, then processed in a suitable manner, if necessary, and stored in a computer memory. In the context of this document, a computer-usable or computer-readable medium may be any medium that can contain, store, communicate, propagate, or transport the program or information for use by or in connection with the system, apparatus, or device. This medium may be located proximate to the device or even remotely and accessed via a network.

Computer program code for carrying out operations of the present invention may be written in any available programming languages or methods, such as but not limited to object-oriented programming languages or procedural programming languages. The program code may execute entirely on the user's device, partly on the user's device, as a stand-alone software package, partly on the user's device and partly on a remote device or entirely on the remote device or server. In the latter scenario, the remote device may be connected to the user's device through a local area network (LAN) or a wide area network (WAN), or the connection may be made to an external computer (for example, through the internet using an Internet Service Provider or any other connection method, such as WiFi or Bluetooth). For purposes of this disclosure, the terms “device” and “computer” may be used interchangeably.

In the drawings accompanying the description that follows, reference numerals and legends (labels, text descriptions) may be used to identify elements. If legends are provided, they are intended merely as an aid to the reader, and should not in any way be interpreted as limiting. The description is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus or device to produce a machine, such that the instructions, which execute via the processor of the device, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture, including instruction means, which implement the function/act specified in the flowchart and/or block diagram block or blocks. Alternatively, the instructions may be loaded onto a device, to cause a series of operational steps to be performed, in place of a computer-readable memory.

Although the ordinal terms first, second, etc. may be used herein to describe various elements, components, and/or modules, these elements, components, and/or modules should not be limited by these terms. These terms are only used to distinguish one element, component, and/or module from another. Thus, a first element, component, and/or module discussed below could be termed a second element, component, and/or module without departing from the teachings of the present invention.

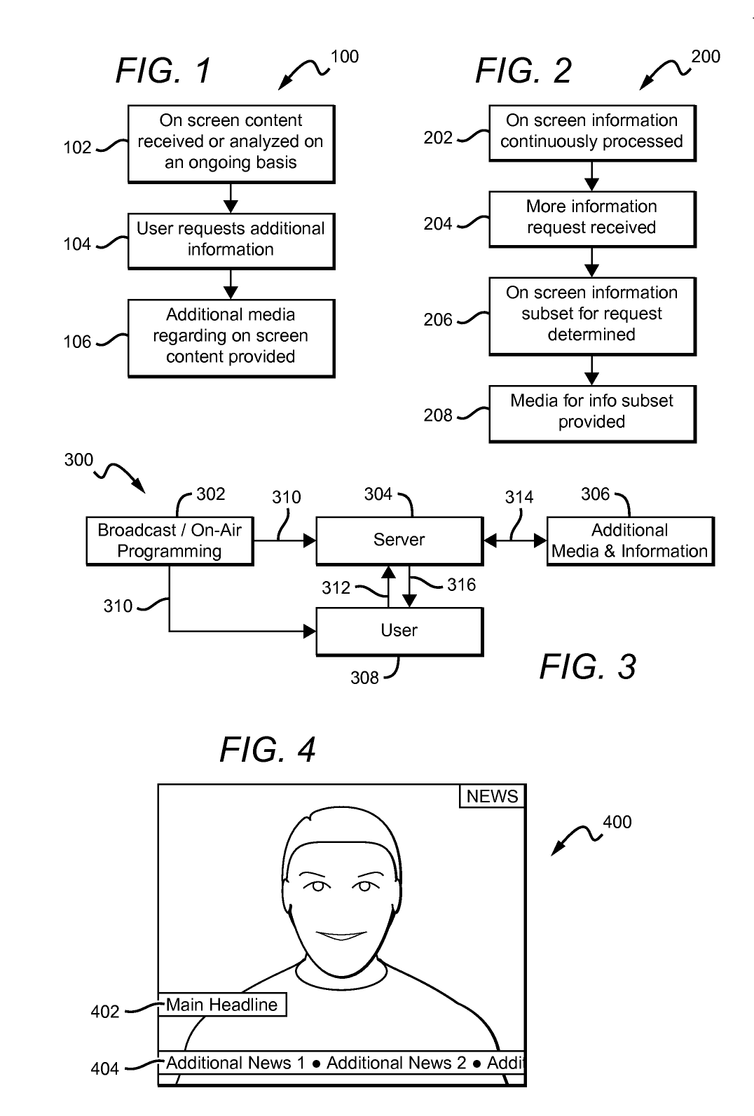

FIG. 1 shows an exemplary flow chart of one way the methods or systems 100 of one embodiment of the present disclosure may be used. In step 102, on screen content from a media segment, broadcast, streamed, or other television program is analyzed on an ongoing basis. This could be for example, headlines or subheadlines displayed on the bottom of a news program, information displayed on the sides of coverage of a sporting event, facts or information displayed over any other television program. In some other embodiments, audio content may also be analyzed. Content may be analyzed by any content recognition method, such as video or audio content recognition, optical character recognition, or comparison of material to various self-prepared or preexisting databases.

Optical character recognition, usually abbreviated to OCR, is the mechanical or electronic conversion of recorded or scanned images of handwritten, typewritten, video or printed text into machine-encoded text. It is widely used as a form of data entry from some sort of original paper data source, whether documents, sales receipts, mail, or any number of printed records, images, or videos. It is a common method of digitizing printed texts, images or videos so that they can be electronically searched, stored more compactly, displayed on-line, and used in machine processes, such as machine translation, text-to-speech and text mining. OCR is a field of research in pattern recognition, artificial intelligence and computer vision. Early versions needed to be programmed with images of each character, and worked on one font at a time. “Intelligent” systems with a high degree of recognition accuracy for most fonts are now common.

Audio and video content recognition systems perform automatic recognition of audio or video content from analog or digital file sources. Application examples include advertisement tracking and recording, music (song) recognition, video recognition, conversion to text from audio or video, and copyright infringement detection. Content sources can be analog, for example radio or television inputs, digital, for example network (ethernet), telephony, high-speed serial connections, or file based formats, such as WAV, MP3, etc. Ongoing content recognition of a television program allows for content parsing and recording for later use. For example, a current broadcast of a news program could be analyzed to parse the subheadlines displayed on screen. The analyzed or parsed information is then stored on a server or any other location the system or method is being run from. In other embodiments, it may not be necessary to parse or analyze on screen information, as the information may already be provided. This information is then stored in the same locations that parsed information may be stored in. In yet other embodiments, both parsed or analyzed information and provided information may be used. In yet other embodiments, it may not be necessary to parse or analyze on screen information, as the information may already be provided to the system via an internal or external source, such as a database or data stream.

In step 104, a user who is watching the analyzed content can use a device, which may be the same device that the television program is being viewed on or another device, such as a mobile device, to request additional information regarding what is displayed on screen. This request may be made via a website, application, or any other method of communicating such a request from the device to the server where the analyzed information resides or can be accessed. This request may be sent merely as a request for information, or may more specifically state what information is requested. For example, if a user is watching a news broadcast, such as CNN®, and the main broadcast is discussing a first topic and the subheadlines, which commonly cover other news items, are regarding a second topic, the user may want to learn more about this second topic, though it is not the focus of the current broadcast. A user may use an embodiment of the system or method of the present disclosure to simply request more information. The system would then receive this request, along with other information, which would allow the server to discern what program the user is watching and the current time of the request. This would allow the server to determine what subheadline was on screen at the time of the request and provide more information about the subheadline the user had seen.

In some embodiments, the user would specify the channel, time and location of viewing. In other embodiments, the system would use device time and location information to determine time and location of broadcast. In yet other embodiments, the broadcast itself may be detected and identified via the system by audio or other recognition methods. In other embodiments, the system may provide the user with a list of one or several passed subheadlines (or list of information choices) that the user may choose from to receive more information about. This would accommodate situations where a user is delayed in making the request for information and desires more information regarding something that was on screen (or heard) on the broadcast a few minutes ago, or at any other point in the present or past.

Lastly, in step 106, once the request is received by the system, the system identifies the information topic, or choices of topics, the user would like more information on. This information is then used to search internal services or databases, or external services or databases, such as the website of the broadcast channel, other channels, or Google® news, for additional information regarding this subheadline. This additional information, or choices of additional information, such as online videos, news articles, images, other broadcasts or a combination of any of these, are then provided to the requesting user.

One simplified example of the system is as follows. A user is viewing CNN®, a story regarding housing is airing, while a subheadline regarding the NBA® is displayed. The user would like to know more regarding the NBA® subheadline and activates the request more information button or application on their mobile device. This request is conveyed to the system, which either has or has been analyzing the current on screen subheadlines on CNN®. The system correlates the time of the request with what was analyzed as being on air at the time of the request. The request is then identified to be for the subheadline on screen at the time of the request, the NBA® subheadline. The system then queries either the CNN® website, other news websites, or a search service, with this subheadline or a portion of this subheadline. The results of this query are then sent to the requesting user. In some embodiments, when the user requests more information, a subset of the last few subheadlines displayed on that channel may be provided to the user, so that the user may choose which one they were requesting more about, in case the user had been delayed in requesting information and in actuality wanted information about the subheadline that was on screen a few seconds or moments ago.

FIG. 2 shows another flow chart of another embodiment of a system or method 200 in accordance with the present disclosure. In step 202, the on screen information of a broadcast program, or any other program, is continuously processed. In other embodiments, audio information may be processed in addition to or instead of on screen information. This video, image, text, or audio may be processed by any method described above, or any other method, which allows for data to be mined from these mediums. In addition, in alternate embodiments, the data may not need to be mined, but may be provided by another source, whether the source is internal or external, such as a database or data stream. In other embodiments, a combination of provided and mined or processed data may be used.

Video broadcasts may be provided to a user on a television using traditional methods, using new digital methods, or any other methods to provide a video transmission to any device with a display. Digital video transmission may include over-the-air transmission according to any of a variety of standardized transmission protocols, such as ATSC, ATSC Mobile, DVB-T, DVB-H, ISDB-T, 1-Seg, DMB-T, and MBMS, among others, as well as proprietary services, such as Sirius® satellite video, MediaFlo, “wireless cable” and the like. In general, any transmission system capable of supporting over-the-air real time transmission of multimedia information may be used. In some embodiments, the viewer may not be watching a program, but may instead be listening to a program, and would like to request information heard. The heard information is processed, as described above by audio content recognition or provided otherwise to the system.

In step 204, a request for more information is received by the system. A user can use a method of communication with the system to request more information regarding something seen or heard on the viewed program. In some embodiments, the user uses an application, a web portal, or webpage to submit the request. In some embodiments this request may be as simple as a request that identifies that requestor (so that a response may be sent) and the time at which the request was made. In other embodiments, the request may include any subset of additional information, such as location, channel or program viewed, preferences of types of additional information requested, or any other details or preferences.

Once such a request is received 204, the system proceeds to determine the subset of information that the viewer has requested in step 206. This may include a list of recent subheadlines to be transmitted to the viewer or user, for them to choose which they want additional content regarding, or this may be a listing of videos, articles, or audio that is related to one or more of the subheadlines. In other embodiments, both may be included, or each in succession.

After the user has viewed this subset, the user may choose what media they would like to view and this media is provided to the user in step 208, either directly, or via link to the media source itself.

Users or viewers can request more information regarding something they have seen or heard on a program from the same device as they are watching or listening to the program on, or a different device, for example if watching on a television, a request may be from a mobile device or computer. For example, one may use an app on their iPhone® and press a “request now” type button to submit their request. This request may travel to the system via a cellular network, wired network, wireless communication, or any other communication method (such as to the television or a set top box), which has a means to communicate with the system and system servers.

Cellular telephone data communications may include protocols from the IS-136 family, CDMA family, and GSM family, including variants of GPRS, so-called “3G” and “4G” standards, UMTS, HSDA, HSPDA, and LTE, among others. In general any transmission system capable of supporting wireless transmission of digital information at a sufficiently high rate may be used.

Short-distance wireless data communication may include protocols, such as IEEE 802.x, Zigbee, Ultra-wideband (UWB), and Bluetooth®. Short-distance wireless data communication may also include optical methods, such as an infrared communications link. In general any transmission system capable of supporting short-range wireless transmission of information at a sufficiently high rate may be used. Bluetooth® is a well-known standard for short-range digital communications that includes variants capable of supporting real-time transmission of audio-visual information. For example, Bluetooth headsets for cellular phones are widely available.

FIG. 3 depicts one embodiment according to the present disclosure of the system and how it can be used 300. Broadcast or on-air programming 302 may be transmitted to a user 308 who views the programming 302. This programming is also optionally received 310 by the server 304 for processing and data mining. In alternative embodiments, the server may directly receive the mined or processed data rather than the programming 302 itself. A user 308 who receives 310 and views the programming 302, may desire to receive additional media or information related to something on the programming. The user 308 then sends a request 312 to the server 304 for such media or information. As described previously, the request may merely be a timestamped request from a user or may include additional information identifying themselves, their preferences, or their viewed programming or information requested.

The server 304 has either received data regarding what information was on the program in proximity to when the request was sent, or the server 304 is receiving the program itself and via content recognition services has determined what information was on the program at a time proximate to when the request was sent. The server then requests 314 from external or internal sources additional media and information 306 related to the topic or topics that were on program. In some embodiments, the server 304 may first provide the user 308 with a subset of information choices to choose from for additional information to be provided. The chosen or determined topic is then queried 314 internally or externally and the resulting additional media and information 306, or a subset thereof, is provided to the server 304 and then sent 316 to the user 308. In some embodiments, the information 306 may be provided directly to the user 308 (not shown).

FIGS. 4, 5 and 6 show exemplary television programming screens that show information that the user may want to receive additional media or information regarding. FIG. 4 shows an exemplary news program 400. This program 400 includes, as many newscasts do, a main headline 402 displayed, stating what the main story which is being discussed is. Below this, or in any other location on screen, is a listing of subheadlines 404, or additional news story excerpts that are displayed, which differ from or expand on the main headline 402 story. For example, the main headline may be regarding today's weather, whereas the subheadlines may be regarding election results. If a user desires more information regarding the election results, there is no way for the user to interact with the television news program directly to request information as the broadcast is set and sent to all viewers, not customized to one. Therefore, the user can instead use the same or different (such as mobile) device to request more information regarding the subheadline. This request can merely be a button press for more information. The user does not need to specify what information is on screen at the moment as the system will determine this by analyzing current programming or via data provided to the system regarding on screen information. This prevents the user from having to go to a website or application and manually searching for a topic, such as “election results.”

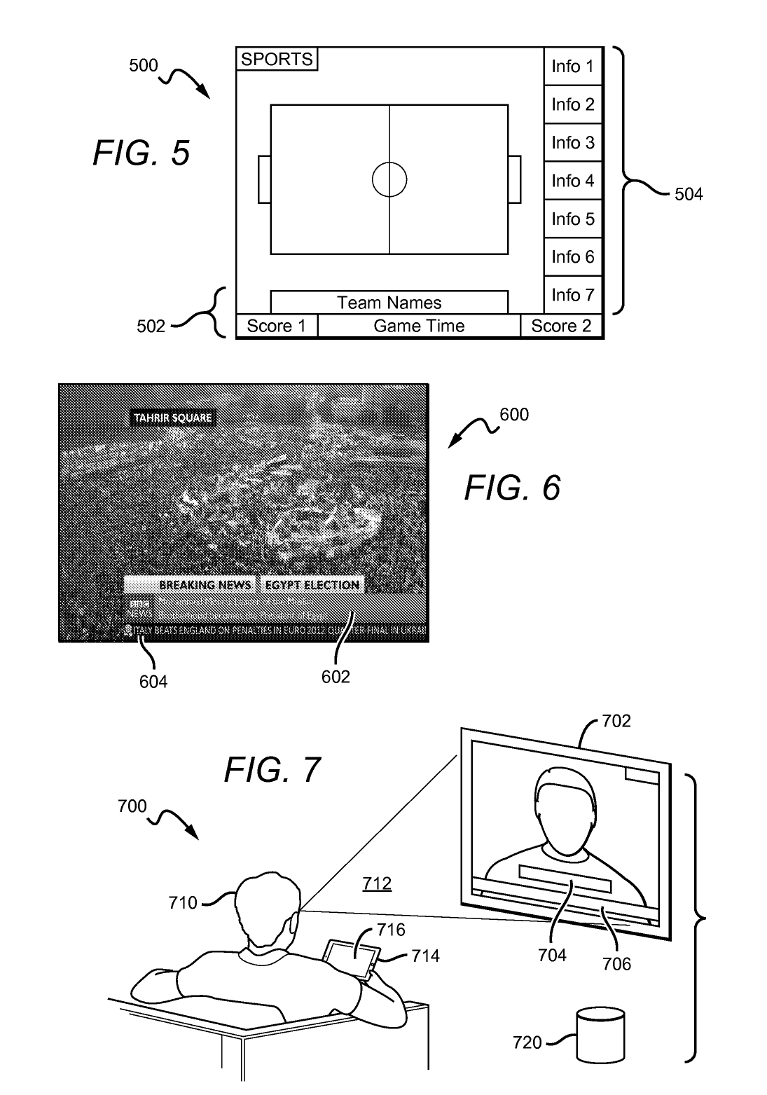

FIG. 5 shows an exemplary sports program 500. The sports program includes information about the current game or story 502 and other information or subheadlines 504. A user may see something in the other information or subheadline 504 section and initiate the request command with the system. The system then would determine what is on screen at the time and deliver related information to the user. For example, the request may specify the viewed sports program, or audio content recognition may allow the application to determine what was on-air at the time of the request. Once the program is determined or reported, the system can use mined or provided information to determine what was on screen. The user may then be prompted regarding the various items on screen so they can choose which topic they would like additional media regarding. Once the choice is conveyed to the system, the system can query the internet or a particular resource for additional media and provide this media directly or by link to the user.

For example, if the user is watching a college football game on ESPN®, and sees a story regarding an NBA® game in the sidebar 504, the user may select the “request more information” button in the application on their mobile phone or device. The request may already specify that the user is watching ESPN®, or the system may determine this by running audio content recognition on the mobile device. The system would then review data (currently analyzed or provided) of what stories were on screen during or proximate in time to the request. If a soccer score and NBA® score were displayed at or before that time, both choices are provided to the user. Either as a choice for which they would like more information about, or with the related media. For example, the system may query Google® news, or ESPNs® website specifically, or any other chosen resource, for information regarding the specified NBA® score, and provide the results or subset of results to the user. The results may be a streamed video from ESPN.com about the game or an article regarding the final score, a live broadcast of the game itself, or videos, images, or articles from other sources.

FIG. 6 is a screenshot of an actual news program. This screenshot 600 shows a BBC® News Broadcast. The broadcast includes a main story with image and headline 602. The broadcast also includes a lower section, sometimes referred to as a ticker, with subheadlines 604. During this newscast the main headline and story are regarding the Egypt Election, Mohammed Moursi becoming President of Egypt. However, the subheadline is regarding a soccer match, specifically, Italy beating England in the Euro 2012 quarter-final match. If a user viewing this broadcast is interested in the soccer subheadline 604, the user may initiate the request process, by pressing for example a “more information now” button, on their mobile device. The system would then receive this request, the time it was requested, and information allowing the system to determine the program being viewed. The system would then respond to the user with either media related to the subheadline displayed at that time, or a listing of choices of recently displayed subheadlines. Displaying such a listing of choices may be beneficial, as a user may not initiate the request immediately after seeing a subheadline. For example, the user may not be able to immediately access their mobile device. Therefore, showing a few choices of recently displayed subheadlines can help account for a delay in the additional media request. Once one or more subheadlines are chosen, related media is provided to the user to view on their mobile device. Related to the example in FIG. 6, this may include replays of the game, articles regarding the game, other newscasts regarding the game, or images or score information.

The method or functionality used by the user to request information may be via a website, an application on a device, or any other communication method. Preferably an application is placed on the user's device. This application would then have a button or functionality to easily and immediately initiate a request for information. This application could also have additional useful functionality, such as the ability to record audio to determine what program they are watching, the ability to determine the user's location, and the ability to record or specify user preferences, such as type of media returned in response to a request, or resources the user would like searched.

In order for the user to have an application for use on their device, action by a user to download a mobile application on their mobile device would occur. Downloading the mobile application can be through establishing a connection between the mobile device and a mobile application server and/or other server, or any other file providing server or service. Downloading can include registration with a mobile application server and/or other server. After installing and, if required by the particular implementation of the system, registering the mobile application. In one specific example, according to one embodiment, a user with an iPhone® may use the Apple App Store to select, download and install the application. Alternatively, the user may download the application from a website, file server, or an equivalent service, such as the Android® Play Store or other similar service. The user can choose to pair their device with other output devices as well.

In some embodiments, the application may also be able to control a television using infrared or other communication scheme. This may be useful, for example, to mute a television when the system retrieves additional information or media which may want to be heard over the television.

The application may allow for user preference data to be selected or saved and used locally or transmitted to the server for use in providing services. The user preference data can be applied to control aspects of the user experience or interaction with respect to the mobile device and the associated system. As an example, the user may specify they only want results from a particular media source or only want to receive videos, or other specific media types, as results. User preference data can therefore be used to control various aspects of the user experience in connection with the system, such as results, device preferences, and associated devices or options.

As used herein, the term “broadcast” refers to a program, transmitted to take place for a viewing audience. The content of the transmission may derive from sources other than the broadcaster itself. The broadcast may include a stream that may be a simulcast of an over-the-air terrestrial, cable or satellite television broadcast or an internet-only television stream.

As used herein, the term “viewer” or “user” refers to a natural person that is the recipient/viewing audience of the broadcast or program. Basically, a viewer is a member of the consuming public that is viewing a television program or broadcast. This broadcast can be any types of media that currently has made programming available for viewing by others, or any future types of media, not contemplated now to be possible, but will be in the future. For example, the viewer is someone who is viewing a transmission which can be a broadcasted video program, a broadcasted live program, a broadcasted sporting events program, a streamed video program, a video podcast, a blog entry, a webpage, a user profile in a social networking website, a video game, a massive multi-player online gaming environment (MMOG), an instant messaging user interface, a text message on a mobile device, an e-mail message on a mobile device, a programming being viewed on a mobile device, a virtual reality environment such as the Second Life.

As used herein, the term “mobile device” may refer to a portable device that may include a processor, a memory, and a display for enabling a user to interact with software applications running on, or in association with, other devices, such as display devices. Example mobile devices may include, but are not limited to, smart phones, other telephones with wireless communication capability, personal digital assistants (PDAs), eBook readers, personal computers (PCs), including laptop PCs and tablet PCs, or any other computing device (wired or wireless) with network access for communicating over a private or public network, such as the internet, WiFi, Bluetooth, or a LAN. A mobile device can include, but not limited to, a cellular phone, a satellite phone, a Personal Data Assistant (PDA), a Blackberry®, an iPhone®, an IPOD®, an ITouch®, a MP3 Player, a MP4 player, an Android® device, a portable television, a laptop, a notebook computer, a desktop computer, a digital media player, portable computers and various classes of wireless handsets, such as phones, mobile devices, tablets, laptops, personal data assistants (PDAs) and mobile internet appliances, any other device which has display and internet access functionalities, or any other portable devices for communication and/or entertainment. The device need not be necessarily portable, but ease of use is increased in such cases. The mobile device may include an infrared remote control module. Mobile internet access may include WiMAX, EDGE, LTE, 4G, 3G, Wi-Fi access points, wired internet access, or other forms of connection to a network or the internet, to name a few. The network may be, any type of public or private network, having any number of nodes, such as routers, switches, and bridges, via a wired or wireless connection.

The term “display device” as used herein may refer generally to an output device for presentation of information. Such information may be received from or based on a broadcast or interaction with a server, mobile device or other device as defined herein. Example display devices may include, but are not limited to, televisions, computer monitors (e.g., connected to a desktop or laptop computer), mobile phone display devices, tablets, projection-based displays, JumboTrons, or any other device for displaying images and/or video.

The device that the application or system is used from by a user may include the ability to receive and interpret GPS signals to resolve their respective locations. In other embodiments, a mobile device may acquire its location from a source other than GPS, such as a different satellite navigation system or a terrestrial source. Location acquisition from a terrestrial source may be accomplished through, for example, base station triangulation, manual input of a location by a mobile device user or advertisement of a static location by an internet access device to which the mobile device is linked wirelessly.

FIG. 7 is an exemplary depiction of a system or method of one embodiment of the present disclosure in use by a user. The system in use 700 includes a user 710 using the system 700. The user 710 is viewing 712 a program 702 on a display device. The program 702 in this example is a news program, which includes primary headline information 704 and additional subheadline information 706. It is understood that other programs may be used with the system and other types or subsets of information may be displayed and analyzed. The user 710 also has a mobile device 714 which includes at least display and communication functionality. The mobile device 714 includes access to the server 720 which runs at least a portion of the system. This access may be via a website or application 716 on the mobile device. In use, the user 710 view 712 the program 702. The user sees a subheadline 706 they would like more information or media regarding. The user 710 then activates a request for more information via the application 716 on their mobile device 714. This sends a request to the server 720, which processes the request and responds to the user's mobile device with the requested content or a list of choices of content which may be provided. As described above, the system already has information regarding what is on screen on the program 702 or is analyzing program information so that it may have such information.

The information or media displayed on the device is typically displayed concurrently with the program, as the programs are generally broadcast and therefore cannot be stopped. However, in some embodiments, the user may be viewing a prerecorded broadcast, and therefore the system would account for the time delay to still provide the correct information in response to the request. The user may have to manually specify the broadcast being viewed in time delay, or the system may be able to detect the program by communicating with the recording/playback device, or via audio content recognition. In addition, in some embodiments, the mobile device may include a method of communication to control the television or play back device, allowing the system or mobile device running a portion of the system to pause or mute the broadcast while the retrieved additional media is shown on the mobile device. This may be accomplished by any connection means such as, but not limited to, Wi-Fi, Bluetooth, or infrared device.

In some of these embodiments, under control of a processor, the system selects the content, such as information and media, based at least in part on conformance of the content with the location information and program being viewed by the user. In some of these embodiments, under control of the processor the system selects the content based at least in part on a determination of compatibility of the content with the mobile device.

A mobile device, which is representative of mobile device 714, is shown in some embodiments to include a location interface, a wireless communication interface, a memory, and an A/V output interface, all of which are communicatively coupled with a processor. The location interface receives GPS signals from GPS satellites and passes GPS signals to the processor. The wireless communication interface, which may use any of the wireless communication methods or types described previously, provides connectivity between the mobile device 714 and an internet access device via a wireless link, such as a WiMAX, EDGE, 3G or Wi-Fi link. A/V output interface includes a display screen, such as a light emitting diode (LED), liquid crystal display (LCD) or plasma screen, and speakers or other devices that produce A/V output for outputting A/V content to a user of mobile device 714.

The location resolver translates GPS signals received from a location interface into GPS coordinates having at least a latitude and longitude. The location resolver stores the GPS coordinates in a location data store, and may time-stamp the GPS coordinates with the acquisition time of the GPS coordinates. The time used to time-stamp GPS coordinates may be obtained from GPS satellites, the internet, or an internal clock, for example. In non-GPS embodiments, location resolver may translate (if necessary), time-stamp and store location information received from an alternative satellite navigation system or terrestrial source.

Requests provided to the system with location reports having GPS coordinates resolved from GPS signals and an identifier associated with the mobile device, such as an IP address, media access control (MAC) address or session identifier result in a response with additional media or information which may be outputted as A/V content via the A/V output interface. Memory of the device stores software executable by a processor, an identifier of mobile device and resolved GPS coordinates, if desired. The memory may include one or more random access memory (RAM) and/or one or more read only memory (ROM) elements, or any other computer readable medium as described previously.

In some of these embodiments, the location information has a degree of accuracy selected by a user of the mobile device. In some of these embodiments, the location information is received from the mobile device in response to a request. In some of these embodiments, the location information is received from the mobile device independent of any request transmitted by the system. In some of these embodiments, the location information comprises global positioning system (GPS) coordinates.

In some embodiments, the system may be aware of or able to detect by a marker the duration of program breaks in the program or broadcast originally viewed by the user. This may assist in determining what information the user was requesting or what times the server needs to or doesn't need to process the original program or broadcast. As in some embodiments, it may not be desirable to process content during a program break, or additional media and information may or may not be provided based on program break content.

In some of these embodiments, the additional media, information or content comprises video content. In some of these embodiments, the content comprises audio content. In some of these embodiments, the content comprises print or written content. In some of these embodiments, the content comprises an advertisement. In some of these embodiments, the content comprises a station identification message. In some of these embodiments, the content comprises a news report.

In other of these embodiments, a method for selecting and sending content for outputting on a mobile device in response to a request comprises the steps of receiving location information associated with the mobile device, detecting the program information desired, and selecting the content for outputting on the mobile device at least in part on the location information.

In other embodiments, a mobile device or server selects additional media content using location information generated on the mobile device and information relating to the time of the request and program watched. In some of these embodiments, a mobile device comprises a location interface, a communication interface, a memory and a processor communicatively coupled with the location interface, the communication interface and the memory, wherein the mobile device receives via the location interface location information associated with the mobile device and receives via the communication interface additional media topic choices and based on user input selects additional media content for outputting on the mobile device. In some of these embodiments, the mobile device under control of the processor outputs the content on the mobile device via at least one audiovisual (A/V) output interface.

In some of these embodiments, the mobile device receives via the communication interface a plurality of content candidates associated with either respective location information or user inputs and selects the content from among the content candidates.

In still other embodiments of the invention, a method for selecting content for outputting on a mobile device comprises the steps of receiving location information associated with the mobile device and selecting content for outputting on the mobile device based at least in part on information determined using the location information.

In still other embodiments of the invention, a method for selecting content for outputting on a mobile device comprises the steps of receiving an information request associated with the mobile device and selecting content for outputting on the mobile device based at least in part on information determined using the request.

In still other embodiments, a server selects, using location information reported by a mobile device, cohabitation content for cohabitating a display screen on the mobile device with the additional media content in addition to original programming. In some of these embodiments, a server comprises a communication interface, a memory and a processor communicatively coupled with the communication interface and the memory, wherein the server receives via the communication interface location information associated with a mobile device receiving a program and under control of the processor selects based at least in part on the location information cohabitation content for shoring a display screen on the mobile device with program content and additional media content.

In some embodiments, the user may elect to request additional media from one device but choose to view and experience the additional media on any number of additional devices. These may be peripheral devices or entirely separate devices, which the requesting device can communicate with. In some embodiments, each device may display the same media. Whereas in other embodiments, each at least one secondary device may be displaying one or more different data streams allowing a user to view multiple additional media items at one time by viewing the requesting device and each at least one secondary device.

In yet other embodiments, the data mined and analyzed from the originally viewed or existing program, may also be used in another manner. Specifically, because this data is already mined and analyzed, and available in a categorized manner, it can also be used to signify to a user when that data is on screen. For example, if a CNN® news channel is analyzed, and the system has determined that the story, headline or subheadline on screen is regarding Topic1, and a user is browsing a website, for example cnn.com, the system may alert the user that Topic1 on the cnn.com website is currently on-air on the CNN® news channel. This functionality could be used to alert users of multiple topics on a plurality of channels or websites as well. This may be used to alert users regarding content on other websites unaffiliated with the original program, or regarding content on other channels as well.

Although the present specification describes components and functions implemented in the embodiments with reference to particular standards and protocols, the disclosure is not limited to such standards and protocols. Each of the standards for internet and other packet switched network transmission (such as TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative, rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly, ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter. Although specific embodiments have been illustrated and described herein, those of ordinary skill in the art appreciate that any arrangement, which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

We claim:

1. A method of providing content, comprising:
receiving a listing of onscreen information related to a media segment;
receiving a user request for additional information related to said media segment;
determining said media segment information displayed within a timeframe of said user's request; and
responding to said request by providing additional information related to said determined onscreen information.

2. The method claim 1, wherein said timeframe is less than ten minutes.

3. The method claim 1, wherein receiving said listing further comprises dynamically analyzing said media segment and data mining said listing of information.

4. The method claim 1, wherein receiving said listing further comprises receiving a transmitted listing of said information.

5. The method claim 1, wherein receiving said listing further comprises retrieving information from a database.

6. The method claim 1, wherein said user request includes at least one of the time of the request, location of the user, channel or media segment being viewed by the user, and/or the type of information the user would like to receive.

7. The method claim 6, wherein said type of information is at least one of hyperlinks, text, video, and/or audio.

8. The method claim 1, wherein responding to said request further comprises providing at least one of a replay of said media segment, information choices, headline choices, articles, videos, hyperlinks, audio, and/or a listing of search results.

9. The method claim 1, further comprising processing said media segment audio information to determine at least one of said media segment broadcast channel and/or particular media segment.

10. The method claim 1, wherein said additional information may be viewed on a device other than the device that the request originated from.

11. The method claim 1, further comprising controlling an additional device wirelessly.

12. The method claim 1, further comprising receiving user preference data.

13. The method claim 12, wherein said additional information is adapted according to said user preference data.

14. A method of providing content, comprising:
analyzing at least a media segment to extract information relating to the content of said media segment;
receiving a user request for additional information related to the media segment;
determining the extracted information which said user's request pertains to; and
responding to user's request by providing additional information related to determined extracted information.

15. The method of claim 14, wherein determining further comprises providing the user with a subset of extracted information and accepting a user's response choice of which portion of said subset said user's request pertains to.

16. The method claim 14, wherein said user request includes at least one of the time of the request, location of the user, channel or media segment being viewed by the user, and/or the type of information the user would like to receive.

17. The method claim 16, wherein said type of information is at least one of hyperlinks, text, video, and/or audio.

18. The method claim 14, wherein responding to said request further comprises providing at least one of a replay of said media segment, information choices, headline choices, articles, videos, hyperlinks, audio, and/or a listing of search results.

19. The method claim 14, further comprising processing said media segment audio information to determine at least one of said media segment broadcast channel and/or particular media segment.

20. The method claim 14, further comprising receiving user preference data.

21. The method claim 20, wherein said additional information is adapted according to said user preference data.

22. A computer program product, comprising:
a non-transitory computer-readable medium comprising:
code for receiving information relating to the content of said media segment;
code for receiving a user request for additional information related to the media segment;
code for determining the extracted information which said user's request pertains to; and
code for responding to user's request by providing additional information related to determined extracted information.

23. The computer program product of claim 22, wherein code for receiving said information further comprises code for analyzing said media segment and data mining said listing of information.

24. The computer program product of claim 22, wherein code for receiving said information further comprises code for receiving a transmitted listing of said information.

25. The computer program product of claim 22, wherein code for receiving said information further comprises code for retrieving information from a database.

26. The computer program product of claim 22, wherein code for determining further comprises providing the user with a subset of extracted information and code for accepting a user's response choice of which portion of said subset said user's request pertains to.

27. The computer program product claim 22, wherein said user request includes at least one of the time of the request, location of the user, channel or media segment being viewed by the user, and/or the type of information the user would like to receive.

28. The computer program product claim 22, wherein said type of information is at least one of hyperlinks, text, video, and/or audio.

29. The computer program product claim 22, wherein code for responding to said request further comprises code for providing at least one of a replay of said media segment, information choices, headline choices, articles, videos, hyperlinks, audio, and/or a listing of search results.

30. The computer program product claim 2, further comprising code for processing said media segment audio information to determine at least one of said media segment broadcast channel and/or particular media segment.

31. The computer program product claim 22, further comprising code for receiving user preference data, wherein said additional information is adapted according to said user preference data.
